(19) United States
(12) Patent Application Publication
(10) Pub. No.: US 2013/0309535 A1
(43) Pub. Date: Nov. 21, 2013

(54) ELECTRONIC APPARATUS AND ELECTRONIC COMPONENT THEREOF

(71) Applicants: Ying-Chieh Hu, Taoyuan County (TW); Weng-Chang Shen, Taoyuan County (TW)

(72) Inventors: Ying-Chieh Hu, Taoyuan County (TW); Weng-Chang Shen, Taoyuan County (TW)

(73) Assignee: HTC CORPORATION, Taoyuan County (TW)

(21) Appl. No.: 13/476,020

(22) Filed: May 21, 2012

(51) Int. Cl. H01M 2/10

(52) U.S. Cl. 429/99; 429/100

(57) ABSTRACT

An electronic component including a housing, a flexible battery and multiple first terminals is provided. The housing includes an outer surface and an inner surface opposite to the outer surface. At least a portion of the flexible battery is embedded in the housing. The multiple first terminals are disposed on the inner surface of the housing and electrically connected with the flexible battery. An electronic apparatus including the electronic component is also provided.

### BACKGROUND OF THE INVENTION

1. Field of the Invention

The invention relates to an electronic apparatus and an electronic component, and more particularly to an electronic apparatus and an electronic component having a flexible battery.

2. Description of Related Art

Benefitting from the advances in semiconductor devices and display technology, electronic apparatuses are unceasingly trending toward increasingly smaller sizes, a plurality of functions and convenient portability. Common hand-held electronic apparatuses include personal digital assistants (PDAs), smart phones and tablet PCs. To make it easy for users to carry and use anywhere, the hand-held electronic apparatuses generally have a battery providing power required for system operation. The increasingly smaller the volumes of the hand-held electronic apparatuses become, the more diversified functions the hand-held electronic apparatuses support. However, a plurality of functions also mean high power consumption. Hence, such apparatuses place a relatively high demand on power. As commonly seen on the market, batteries installed in the hand-held electronic apparatuses have a larger capacitance. For instance, batteries of smart phones have a capacitance of over 1500 mAh while a capacitance of more than 2500 mAh is often necessary for batteries of tablet PCs. The battery with a larger capacitance has a larger volume. Therefore, the battery volume often has a direct impact on volume of electronic products as to the hand-held electronic products.

However, lightweight, thin and flat hand-held electronic apparatuses have gradually become the mainstream in the market as consumers have increasingly higher demands on sizes of the hand-held electronic apparatuses. An oversized battery becomes a dilemma in design as the products trend to be thin-sized and lightweight.

### SUMMARY OF THE INVENTION

The invention provides an electronic component including a flexible battery embedded in a housing.

The invention provides an electronic apparatus including the electronic component capable of increasing battery capacity of the electronic apparatus.

The invention provides an electronic component including a housing, a flexible battery and a plurality of first terminals. The housing includes an outer surface and an inner surface opposite to the outer surface. At least a portion of the flexible battery is embedded in the housing. The first terminals are disposed on the inner surface of the housing and electrically connected to the flexible battery.

The invention provides an electronic apparatus including a main body and an electronic component. The main body includes a plurality of second terminals. The electronic component includes a housing, a flexible battery and a plurality of first terminals. The housing includes an outer surface and an inner surface opposite to the outer surface. The flexible battery is embedded in the housing. The first terminals are disposed on the inner surface of the housing and electrically connected to the flexible battery.

In an embodiment of the invention, the first terminals are a plurality of elastic terminals, and the second terminals are a plurality of pads.

In an embodiment of the invention, the first terminals are a plurality of pads, and the second terminals are a plurality of elastic terminals.

In an embodiment of the invention, the flexible battery is capable of withstanding a temperature of at least 100 degrees Celsius.

In an embodiment of the invention, the flexible battery is embedded in the housing by insert molding.

In an embodiment of the invention, the housing is an outer housing of the electronic apparatus.

In an embodiment of the invention, the housing is a back cover of the electronic apparatus.

In an embodiment of the invention, the electronic apparatus further includes a main battery disposed in the main body and electrically connected to the main body.

In an embodiment of the invention, the flexible battery and the main battery are electrically connected to the main body respectively.

In an embodiment of the invention, the flexible battery is electrically connected to the main battery and to the main body respectively.

In an embodiment of the invention, the flexible battery is electrically connected to the main battery, and the main battery is electrically connected to the main body.

Based on the above, the electronic apparatus of the invention is capable of increasing battery capacity and increasing use time of the electronic apparatus better.

Embodiments are illustrated with reference to the accompanying drawings in detail below to make the aforementioned features and advantages of the invention more comprehensible.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the invention.

FIGS. 1A and 1B are respectively a three-dimensional view and a cross-sectional view of an electronic component according to an embodiment of the invention.

FIG. 2A is an explosive view of an electronic apparatus including the electronic component of FIG. 1 according to an embodiment of the invention.

FIG. 2B is a three-dimensional view of the electronic apparatus of FIG. 2A with the electronic component removed.

FIG. 2C is a partial enlarged diagram illustrating the dotted-line area of FIG. 2B.

FIG. 3A is a three-dimensional view of an electronic component according to another embodiment of the invention.

FIG. 3B is a cross-sectional view of first terminals contacting second terminals of the embodiment of FIG. 3A.

FIGS. 4-6 are block diagrams illustrating a connection relationship among a main body, a flexible battery and a main battery of an electronic apparatus according to a plurality of embodiments of the invention.

FIG. 7 is a circuit connection diagram of an electronic apparatus according to an embodiment of the invention.

### DESCRIPTION OF EMBODIMENTS

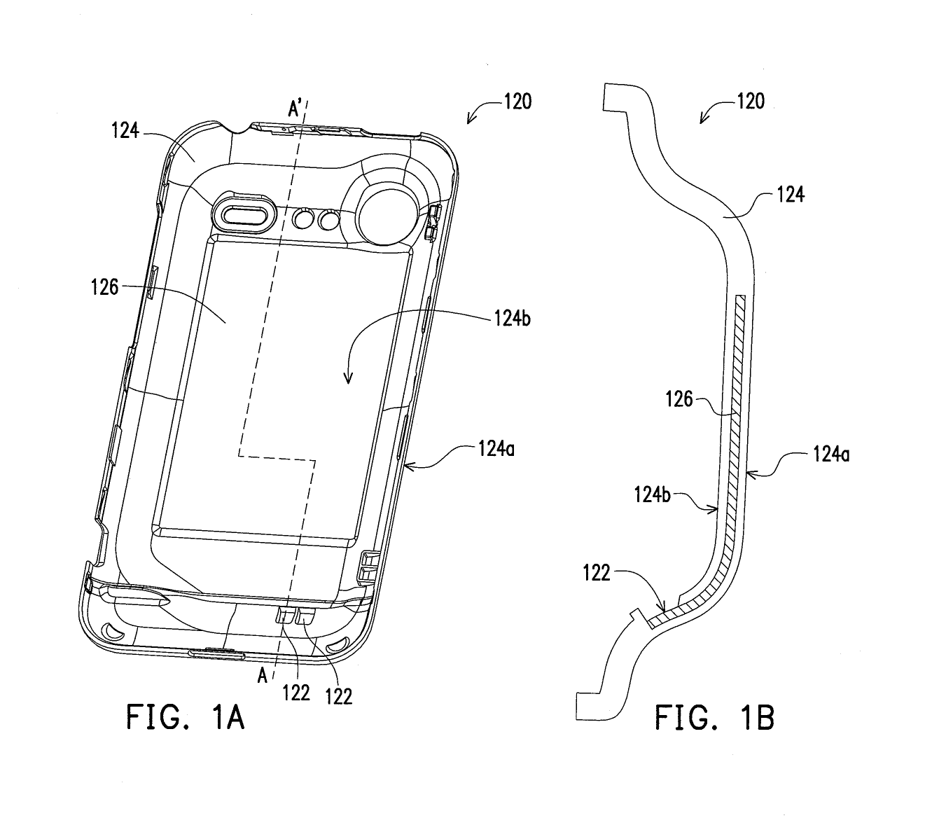

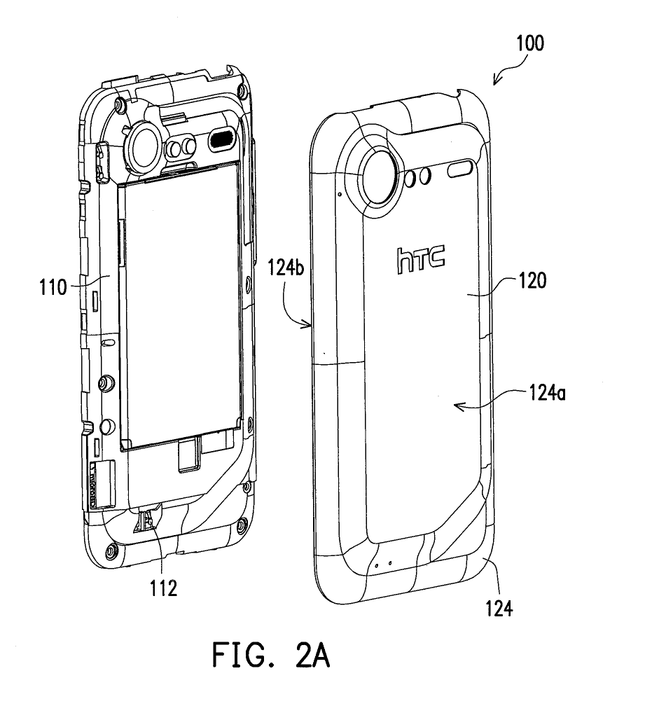

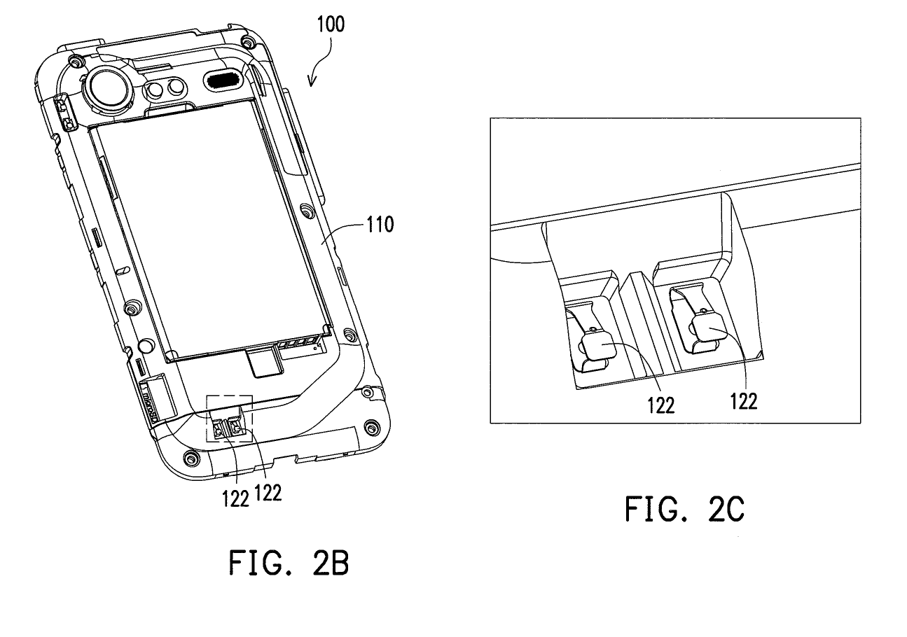

FIGS. 1A and 1B are respectively a three-dimensional view and a cross-sectional view of an electronic component according to an embodiment of the invention. FIG. 2A is an explosive view of an electronic apparatus including the electronic component of FIG. 1 according to an embodiment of the invention. Referring to FIGS. 1A to 2A, an electronic apparatus 100 of the invention includes a main body 110 and an electronic component 120. The main body 110 includes a plurality of second terminals 122. The electronic component 120 includes a housing 124, a flexible battery 126 and a plurality of first terminals 112. The housing 124 includes an outer surface 124a and an inner surface 124b opposite to the outer surface 124a. The flexible battery 126 is embedded in the housing 124. In the present embodiment, the flexible battery 126 is embedded in the housing 124 by insert molding.

In a fabricating process of insert molding forming, a plastic material is extruded by a screw in a molten state and injected at high speed and high pressure into a mold to fill. The plastic material is, for example, polycarbonate (PC), and a melting plastic material at the time of injection is at a temperature of about 300 degrees Celsius. The mold also has a temperature of about 100 degrees Celsius. Therefore, the flexible battery has good tolerance to high temperatures as compared with a conventional aluminum package battery. For instance, the flexible battery is capable of withstanding a temperature of at least 100 degrees Celsius, so that after injection molding, the flexible battery is still capable of retaining good power storage effects. Moreover, the flexible battery has a slight impact on thickness of an electronic component when applied in insert molding due to a very thin thickness of the flexible battery. In this embodiment, a plurality of first terminals 112 are disposed on the inner surface 124b of the housing 124 and electrically connected to the flexible battery 126, wherein the first terminals 112 are disposed on the inner surface 124b by a process such as laser etching. Furthermore, the first terminals 112 may be disposed on the flexible battery 126 directly. Structural elements inside the mold, such as a core or a pin, directly rely on a surface of the first terminals 112 during the process of insert molding. After plastic injection, terminals of the electronic component 120 are exposed without being wrapped by plastic to be electrically connected to the main body 110.

In an embodiment of the invention, the flexible battery 126 is embedded in the electronic component 120 of the electronic apparatus 100 by insert molding, so that not only does the electronic component 120 serve as a power source for the electronic apparatus 100, the housing 124 of the electronic component 120 is further used as an outer housing of the electronic apparatus 100, such as a back cover. The electronic component of the invention used in electronic apparatuses such as smart phones allows mobile phones to have a larger electricity capacity. If the electronic component of the invention is applied in electronic apparatuses such as tablet PCs, the flexible battery has a larger electricity capacity as the flexible battery has a larger distribution area due to an enormous area of the back cover. Use time of the electronic apparatus is thus increased without substantially increasing the thickness of the electronic apparatus.

A variety of arranging methods that the electronic apparatus of the invention may adopt are listed below. FIG. 2B is a three-dimensional view of the electronic apparatus of FIG. 2A with the electronic component removed. FIG. 2C is a partial enlarged diagram illustrating the dotted-line area of FIG. 2B. Referring to FIG. 2B and FIG. 2C, first, connection methods of the electronic component 120 and the main body 110 of the electronic apparatus 100 include electrical connection via mutual contact of the first terminals 112 and the second terminals 122 other than structurally locking with mechanisms respectively disposed on the electronic component 120 and the main body 110. The first terminals 112 and the second terminals 122 also have the following arranging methods.

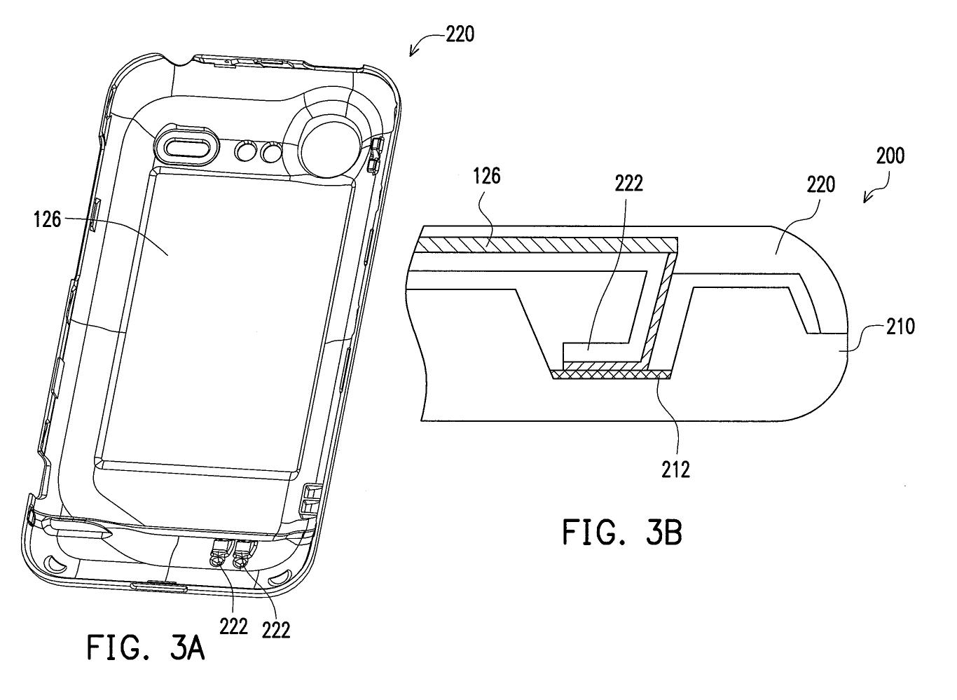

In the embodiment illustrated in FIG. 2B and FIG. 2C, the first terminals 112 on the main body 110 are a plurality of elastic terminals. The second terminals 122 in correspondence to the first terminals 112 are a plurality of pads. In more detail, the first terminals 112 are, for example, a plurality of springs and a material of the springs is, for example, beryllium copper (Be—Cu) in this embodiment. The springs are electrically connected to the main body 110; for example, the springs are fastened to a printed circuit board of the main body 110 via a surface mounting technology (SMT) and electrically connected to the printed circuit board. The second terminals 122 are, for example, a plurality of metal boards. FIG. 3A is a three-dimensional view of an electronic component according to another embodiment of the invention. FIG. 3B is a cross-sectional view of first terminals contacting second terminals of the embodiment of FIG. 3A. In an electronic apparatus 200 of this embodiment, first terminals 212 of a main body 210 may also be a plurality of pads while second terminals 222 relative to the first terminals 212 in an electronic component 220 are a plurality of elastic terminals. However, the invention is not intended to limit structural forms of the first terminals and the second terminals. Whatever makes the two electrically connected may serve as the structural forms of the terminals of the invention.

In this embodiment, the electronic apparatus 100 further includes a main battery 130. The main battery 130 is disposed in the main body 110 and electrically connected to the main body 110. The main battery 130 disposed in the electronic apparatus 100 serves as a main source of power. The main battery 130 and the flexible battery 126 of the electronic component 120 have many connection ways. Several embodiments are described below to explain a connection relationship among the main body 110, the flexible battery 126 and the main battery 130.

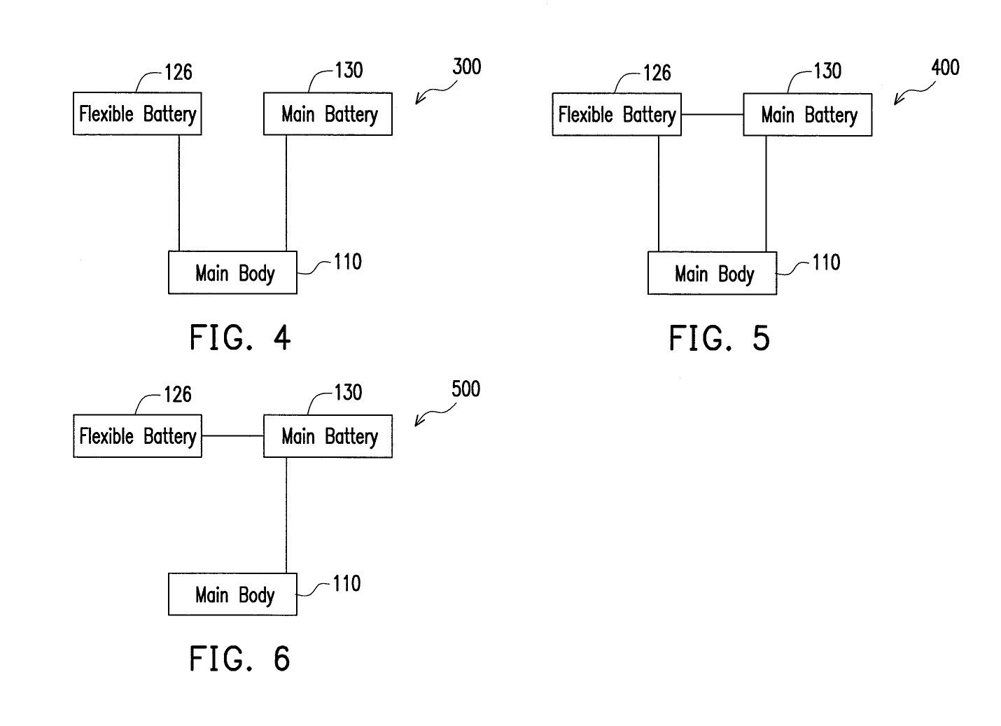

FIG. 4 is a block diagram illustrating a connection relationship among a main body, a flexible battery and a main battery of an electronic apparatus according to an embodiment of the invention. In this embodiment, the flexible battery 126 and the main battery 130 are electrically connected to the main body 110 respectively. In detail, the flexible battery 126 and the main body 110 of the present embodiment are electrically connected, and the main battery 130 is electrically connected to the main body 110, but the flexible battery 126 and the main battery 130 are not directly electrically connected. An electronic apparatus 300 is predetermined to be supplied with power via the main battery 130 first. At the time when power outputted from the main battery 130 is lower than a predetermined voltage, the flexible battery 126 supplies power instead. Moreover, the flexible battery 126 charges the main battery 130 in a reverse direction via the main body 110.

FIG. 5 is a block diagram illustrating a connection relationship among a main body, a flexible battery and a main battery of an electronic apparatus according to another embodiment of the invention. In this embodiment, the flexible battery 126 is electrically connected to the main battery 130 and the main body 110 respectively. In detail, three of the flexible battery 126, the main battery 130 and the main body 110 are electrically connected to one another. An electronic apparatus 400 is predetermined to be supplied with power via the main battery 130 first. At the time when a voltage of power outputted from the main battery 130 is lower than a predetermined voltage, the flexible battery 126 supplies power instead. Moreover, the flexible battery 126 directly charges the main battery 130.

FIG. 6 is a block diagram illustrating a connection relationship among a main body, a flexible battery and a main battery of an electronic apparatus according to still another embodiment of the invention. In this embodiment, the flexible battery 126 and the main battery 130 are electrically connected, and the main battery 130 is electrically connected to the main body 110. In detail, three of the flexible battery 126, the main battery 130 and the main body 110 are electrically connected in series. An electronic apparatus 500 is predetermined to be supplied with power via the main battery 130 first. When a voltage of power outputted from the main battery 130 is lower than a predetermined voltage, the flexible battery 126 supplies power to the main body 110 via the main battery 130. In addition, the flexible battery 126 directly charges the main battery 130.

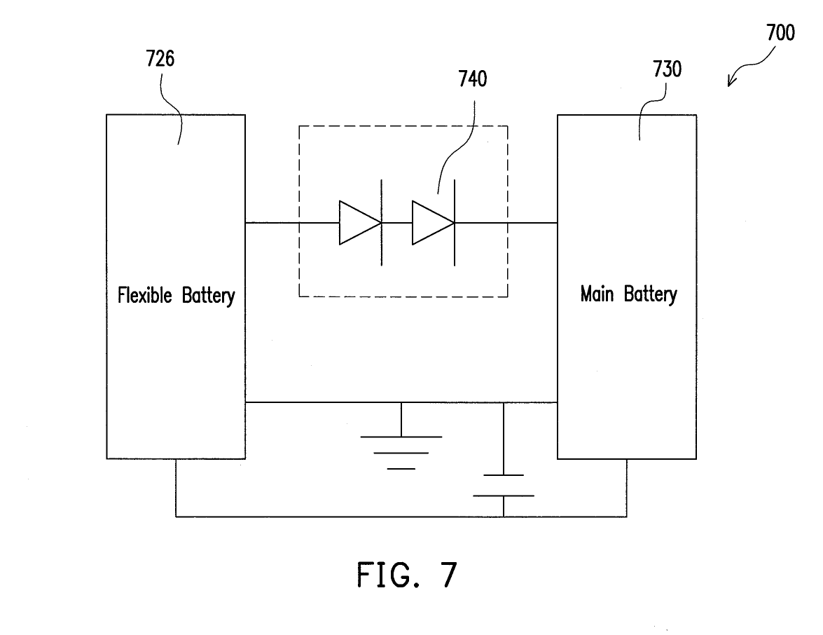

The several embodiments described above illustrate connection relationships among the main body 110, the flexible battery 126 and the main battery 130 and power supply sequences of the three. An embodiment is described below to explain a switch mechanism of a power supply sequence between the flexible battery 126 and the main battery 130. FIG. 7 is a circuit connection diagram of an electronic apparatus according to an embodiment of the invention. The circuit connection diagram is adapted for any embodiment in FIGS. 4-6. In this embodiment, one or more diodes 740 (shown as two in the figure) is disposed between a flexible battery 726 and a main battery 730. When the flexible battery 726 and the main battery 730 are not electrically connected, the diodes 740 are disposed in a main body 710 to deploy a power supply sequence.

After a long time of use of an electronic apparatus 700, a voltage of power outputted from the main battery 730 drops. When a voltage difference of outputted power between the main battery 730 and the flexible battery 726 is greater than or equal to a total value of start-up voltages of two diodes 740 in series, the flexible battery 726 initiates a current outflow, and the current flows into the main battery 730 to charge or to supply power to the main body 710. The diodes 740 limit a current direction to prevent the current of the main battery 730 from flowing into the flexible battery 726. For instance, the main battery 730 and the flexible battery 726 of the electronic apparatus 700 are, for example, a battery with a saturation voltage of 4 V while each of the diodes 740 has a start-up voltage of 0.7 V. The diodes 740, electrically connected in series, allow the current to flow in only one direction—from the flexible battery 726 to the main battery 730. When the voltage of power outputted from the main battery 730 is lower than 2.6V, the voltage difference of outputted power between the main battery 730 and the flexible battery 726 will be greater than 1.4 V, i.e. a total value of start-up voltages of two diodes 740 in series. At this point, the flexible battery 726 commences power supply or charges the main battery 730. In this way, current management is more efficient. Power waste or battery damage resulting from simultaneous power supply of the main battery 730 and the flexible battery 726 is prevented. However, the invention is not intended to limit the switch mechanism of the power supply sequence of the flexible battery 126 and the main battery 130 and a charging mechanism of the flexible battery 126 for the main battery 130.

In summary, in the electronic apparatus of the invention, a flexible battery is embedded in the inner of the housing structure of the electronic component, enabling the electronic component to be used not only as a source of power supply but also as a structural element of the electronic apparatus. As a result, not only is the battery capacity of the electronic apparatus increased, the size of the electronic apparatus is not substantially increased. In addition, more efficient power management between the flexible battery and the main battery is achieved as the diode, disposed between the flexible battery and the main battery, allows current to flow in only one direction.

Though the above embodiments have disclosed the invention, they are not intended to limit the invention. Modifications and alterations may be made by one of ordinary skill in the art without departing from the spirit and scope of the invention. Therefore, the protection scope of the invention falls in the appended claims.

What is claimed is:

1. An electronic component, comprising:
a housing comprising an outer surface and an inner surface opposite to the outer surface;
a flexible battery with at least a portion thereof embedded in the housing; and
a plurality of first terminals disposed on the inner surface of the housing and electrically connected to the flexible battery.

2. The electronic component according to claim 1, wherein the first terminals are a plurality of elastic terminals.

3. The electronic component according to claim 1, wherein the first terminals are a plurality of pads.

4. The electronic component according to claim 1, wherein the flexible battery is capable of withstanding a temperature of at least 100 degrees Celsius.

5. The electronic component according to claim 1, wherein the flexible battery is embedded in the housing by insert molding.

6. The electronic component according to claim 1, wherein the housing is an outer housing of an electronic apparatus.

7. The electronic component according to claim 1, wherein the housing is a back cover of an electronic apparatus.

8. The electronic component according to claim 1, wherein the flexible battery is electrically connected to an electronic apparatus.

9. The electronic component according to claim 1, wherein the flexible battery is electrically connected to an electronic apparatus, and the electronic apparatus comprises a main battery.

10. An electronic apparatus, comprising:
a main body comprising a plurality of second terminals; and
an electronic component, comprising:
a housing assembled to the main body and comprising an outer surface and an inner surface opposite to the outer surface;
a flexible battery with at least a portion thereof embedded in the housing; and
a plurality of first terminals disposed on the inner surface of the housing and electrically connected to the flexible battery, wherein the flexible battery is electrically connected to the main body when the first terminals contact the second terminals.

11. The electronic apparatus according to claim 10, wherein the first terminals are a plurality of elastic terminals, and the second terminals are a plurality of pads.

12. The electronic apparatus according to claim 10, wherein the first terminals are a plurality of pads, and the second terminals are a plurality of elastic terminals.

13. The electronic apparatus according to claim 10, wherein the flexible battery is capable of withstanding a temperature of at least 100 degrees Celsius.

14. The electronic apparatus according to claim 10, wherein the flexible battery is embedded in the housing by insert molding.

15. The electronic apparatus according to claim 10, wherein the housing is an outer housing of the electronic apparatus.

16. The electronic apparatus according to claim 10, wherein the housing is a back cover of the electronic apparatus.

17. The electronic apparatus according to claim 10, further comprising a main battery disposed on the main body and electrically connected to the main body.

18. The electronic apparatus according to claim 17, wherein the flexible battery and the main battery are electrically connected to the main body respectively.

19. The electronic apparatus according to claim 17, wherein the flexible battery is electrically connected to the main battery and the main body respectively.

20. The electronic apparatus according to claim 17, wherein the flexible battery is electrically connected to the main battery, and the main battery is electrically connected to the main body.
